(19) United States
(12) Patent Application Publication
(10) Pub. No.: US 2008/0297353 A1
(43) Pub. Date: Dec. 4, 2008

(54) Deactivation for Magnetomechanical Marker Used in Electronic Article Surveillance

(75) Inventors: Hubert A. Patterson, Boca Raton, FL (US); Nen-Chin Liu, Wellington, FL (US); Eugenio Morgado, Royal Palm Beach, FL (US)

Correspondence Address: IP LEGAL DEPARTMENT;TYCO FIRE & SECURITY SERVICES, ONE TOWN CENTER ROAD, BOCA RATON, FL, 33486, US

(73) Assignee: Sensormatic Electronics Corporation, Boca Raton, FL (US)

(21) Appl. No.: 11/658,387

(22) PCT Filed: Aug. 5, 2005
(86) PCT No.: PCT/US05/27992

§ 371 Date: Jan. 23, 2007

Related U.S. Application Data
(60) Provisional application No. 60/600,662, filed on Aug. 11, 2004.

(51) Int. Cl. G08B 13/22

(52) U.S. Cl. 340/572.3; 340/572.1

(57) ABSTRACT

A marker for use in a magnetomechanical electronic article surveillance system is described. The EAS marker includes at least one resonator, a housing configured to provide a cavity for vibration of the at least one resonator, a first, magnetized, biasing element configured to provide a biasing magnetic field for the at least one resonator, and a second, non-magnetized, biasing element.

### BACKGROUND OF THE INVENTION

1. Field of the Invention

This invention relates generally to magnetomechanical markers used in electronic article surveillance (EAS) systems and methods of making same.

2. Description of the Related Art

It is known to provide electronic article surveillance (EAS) systems to prevent or deter theft of merchandise from retail establishments. In a typical EAS system, markers are utilized that are configured to interact with an electromagnetic or magnetic field generated by equipment placed, for example, at an exit of a store. Removable tags or labels are typically placed on the article at the store or at an intermediate location. Alternatively, tags or labels may be integrated into the article during manufacture in a process known as “source tagging.”

If a marker is brought into the field or “interrogation zone” of the field generating equipment, the presence of the marker is detected and an alarm is generated. Removable markers are typically removed at the checkout counter upon payment for the merchandise. Other types of markers, such as markers integrated with the article, are deactivated at the checkout counter, for example, by a deactivation device that changes an electromagnetic or magnetic characteristic of the marker so that the presence of the marker will no longer be detected within the interrogation zone.

One type of EAS marker (sometimes referred to as EAS tags or labels) employs a magnetomechanical marker that includes a magnetostrictive resonating element. Examples of such magnetomechanical markers are disclosed in U.S. Pat. No. 4,510,489 to Anderson et al., U.S. Pat. No. 5,469,140 to Liu et al., and U.S. Pat. No. 5,495,230 to Lian. The resonating element in such markers is typically formed of a ribbon-shaped length of a magnetostrictive amorphous material contained in an elongated housing in proximity to a biasing magnetic element. The magnetostrictive element is fabricated such that it is resonant at a predetermined frequency when the biasing element has been magnetized to a certain level. Within the interrogation zone of the EAS system, a suitable oscillator provides an AC magnetic field at the predetermined frequency and the magnetostrictive element mechanically resonates at this frequency upon exposure to the field when the biasing element has been magnetized to a certain level. Such markers are also referred to as single bias markers.

Deactivation of these magnetomechanical markers is typically performed by degaussing the biasing element so that the magnetostrictive element ceases to be mechanically resonant or its resonant frequency is changed. However, when the biasing element is degaussed, although the marker is no longer detectable in a magnetomechanical surveillance system, the magnetostrictive element may nevertheless act as an amorphous magnetic element that can still produce harmonic frequencies in response to an electromagnetic interrogating field. This is undesirable because after a purchaser of an item bearing the magnetomechanical marker has had the marker degaussed at the checkout counter, that purchaser may then enter another retail shop where a harmonic EAS system may be in use. In such a scenario, it would be possible for the degaussed marker to set off an alarm because it may generate harmonic frequencies in response to an interrogation signal in the second retail store.

In addition, with this particular degaussing type of deactivation process, there is risk that the marker can be accidentally reactivated by the presence of a strong magnetic field, for instance, a permanent magnet buried on the ground of parking lots for a shopping cart locking device. Therefore, as an example, when these labels that include magnetomechanical markers are integrated into items such as shoes or clothes (such as in source tagging), customers that have previously purchased such articles may be wearing these articles as they enter other establishments. If these magnetomechanical markers have been accidentally reactivated, these markers may unintentionally generate an alarm.

### SUMMARY OF THE INVENTION

A marker for use in a magnetomechanical electronic article surveillance system is provided. The marker may comprise at least one resonator, a housing configured to provide a cavity for vibration of said at least one resonator, a first, magnetized, biasing element configured to provide a biasing magnetic field for said at least one resonator, and a second, non-magnetized, biasing element.

A method of deactivating a marker within a magnetomechanical electronic article surveillance system is also provided. The method may comprise providing the marker with a resonator and configuring a first biasing element for use in the marker at a first magnetization level. The method further may comprise configuring a second biasing element for use in the marker at a second magnetization level and providing that the magnetization levels for the first and second biasing elements will be substantially equal upon a subsequent exposure to a magnetic field having a predetermined strength.

An electronic article surveillance (EAS) system marker may be configured to resonate at a predetermined frequency is provided. After deactivation, the marker may be configured to resonate at a frequency different than the predetermined frequency upon subsequent exposure to a magnetic field.

A marker for use in a magnetomechanical electronic article surveillance (EAS) system is also provided that comprises at least one resonator, a housing configured to allow vibration therein of the at least one resonator, at least one permanently magnetized biasing element within the housing configured to provide a biasing magnetic field for the at least one resonator, and at least one biasing element within the housing. These biasing elements have a coercivity that allows magnetization and demagnetization of the biasing elements.

### BRIEF DESCRIPTION OF THE DRAWINGS

For a better understanding of various embodiments of the invention, reference should be made to the following detailed description which should be read in conjunction with the following figures wherein like numerals represent like parts.

FIG. 1 is a diagram of an electronic article surveillance system illustrating a magnetomechanical marker within a field of interrogation generated by the system.

FIG. 2 is a diagram of a marker in accordance with an embodiment of the invention.

FIG. 3 is a chart illustrating a comparison of label frequency and amplitude before and after a second biasing element is incorporated into the marker.

FIG. 4 is a chart illustrating the frequency and amplitude change of a double-bias marker after deactivation.

FIG. 5 is a chart illustrating the frequency and amplitude change of a double-bias marker after exposure to a pulsed DC field.

FIG. 6 is a chart illustrating the frequency and amplitude change of a single-bias marker after exposure to a pulsed DC field.

### DETAILED DESCRIPTION OF THE INVENTION

For simplicity and ease of explanation, the invention will be described herein in connection with various embodiments thereof. Those skilled in the art will recognize, however, that the features and advantages of the various embodiments may be implemented in a variety of configurations. It is to be understood, therefore, that the embodiments described herein are presented by way of illustration, not of limitation.

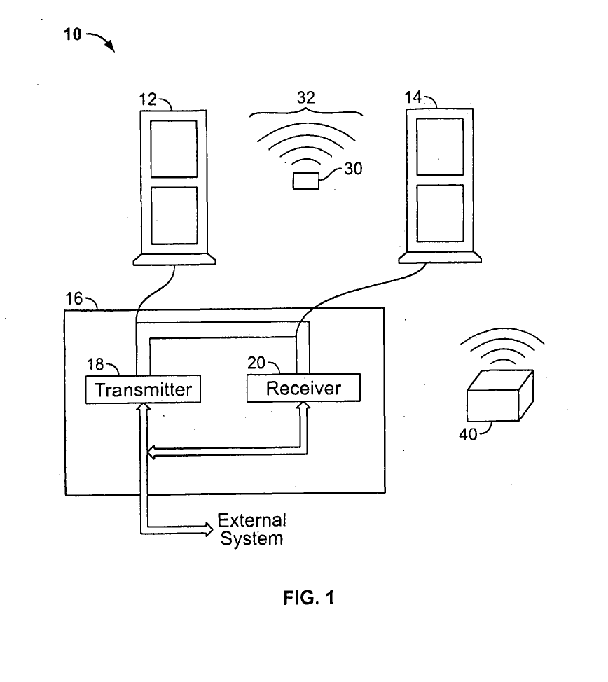

FIG. 1 illustrates an EAS system 10 that may include a first antenna pedestal 12 and a second antenna pedestal 14. The antenna pedestals 12 and 14 may be connected to a control unit 16 that may include a transmitter 18 and a receiver 20. The control unit 16 may be configured for communication with an external device, for example, a computer system controlling or monitoring operation of a number of EAS systems. In addition, the control unit 16 may be configured to control transmissions from transmitter 18 and receptions at receiver 20 such that the antenna pedestals 12 and 14 can be utilized for both transmission of signals for reception by an EAS marker 30 and reception of signals generated by the excitation of EAS marker 30. Specifically, such receptions typically occur when the EAS markers 30 are within an interrogation zone 32, which is generally between antenna pedestals 12 and 14.

System 10 is representative of many EAS system embodiments and is provided as an example only. For example, in an alternative embodiment, control unit 16 may be located within one of the antenna pedestals 12 and 14. In still another embodiment, additional antennas that only receive signals from the EAS markers 30 may be utilized as part of the EAS system. Also a single control unit 16, either within a pedestal or located separately, may be configured to control multiple sets of antenna pedestals. As is known, a deactivation device 40, for example, incorporated into the checkout counter of a retailer, may be utilized to degauss EAS markers 30 upon purchase of the item to which, or into which, the EAS marker 30 is attached or integrated. As further described below, degaussing of a biasing element within EAS marker 30 results in a non-alarm (the signals generated by excitation of EAS marker 30 are not recognized by receiver 20) when EAS marker 30 passes through the interrogation zone 32.

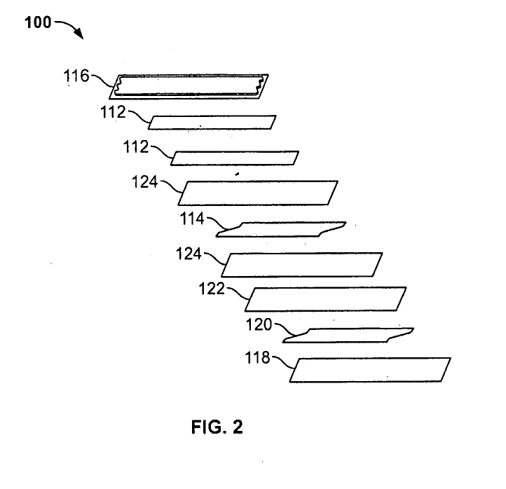

FIG. 2 is an illustration of an embodiment of a magnetomechanical EAS marker 100, which is also sometimes referred to as a label. EAS marker 100 may include one or more magnetostrictive resonators 112 that may be located in a cavity that provides sufficient space for the resonator(s) 112 to vibrate at a resonant frequency. The resonant frequency of resonators 112 is determined, at least in part, by a length and width of resonators 112 and a strength of a magnetic field near such resonators 112. A first biasing element 114 may be attached to a housing 116 using an adhesive layer 118. After fully saturating biasing element 114 through magnetization, the label 100 is in the active state. The resonant frequency and amplitude of the resonant frequency generated within label 100 is optimized, for a particular detection algorithm, based on a field strength provided by biasing element 114.

Marker 100 may include an additional biasing element 120, which is degaussed, and which has the same dimensions and is fabricated from the same material as the biasing element 114. The term “marker” (generally indicated by reference numeral 100 in FIG. 2) generally refers to the combination of the magnetostrictive element (resonator 112) and the biasing elements 114 and 120 contained within a housing 116 and capable of being attached or associated with merchandise to be protected from theft. In various embodiments, marker 100 is sealed by the attachment of the adhesive layer 118 to the housing 116. Marker 100 is also sometimes referred to herein as a double bias marker to distinguish from the single bias markers described above and well known in the art. Markers 100 may be attached to an exterior of certain items using various methods (e.g., adhesives) and also may be contained within the packaging of other items. Also, markers 100 may be permanently embedded within certain items (e.g., molded within) during production of the item.

The additional biasing element 120, may be referred to herein as a second biasing element. This additional, non-magnetized, biasing element 120 also may be attached to the label assembly 100 using a second adhesive layer 122 and lid stock layer 124. In the embodiment, the additional biasing element 120 has minimal impact to the active operation of biasing element 114, because being non-magnetic, the biasing element 120 does not significantly alter the magnetic circuit. In alternative embodiments, the biasing elements 114 and 120 may be oriented within the marker 100 in one of a stacked orientation (as illustrated in FIG. 2), a side-by side orientation. In other embodiments, marker 100 may include multiple magnetized biasing elements 114 and multiple non-magnetized biasing elements 120 oriented in a stacked configuration, a side-by-side configuration, and a combination of a stacked and side-by-side configuration.

Therefore, when biasing element 114 is degaussed, for example, by a deactivation device at a store checkout counter, the additional biasing element 120 remains degaussed. However, should biasing element 114 become magnetized once again, for example, by exposure to a strong magnetic field, the additional biasing element 120 should also become magnetized. The effect of having both the biasing element 114 and the additional biasing element 120 magnetized is that together the biasing elements 114 and 120 yield a field strength that is greater than the filed generated by a single magnetized biasing element. This increased field strength results in a change in the functional operation of resonators 112. Specifically, when both the biasing element 114 and the additional biasing element 120 are magnetized, label 100 is effectively deactivated as the label 100 will resonate at a frequency that is different than the frequency at which EAS marker 100 was originally intended to resonate. Therefore, even if label 100 passes through an interrogation zone of an EAS system (e.g., EAS system 10 (shown in FIG. 1)), an alarm is not activated since the resonator 112 is operating at a frequency outside of a frequency range of EAS system 10.

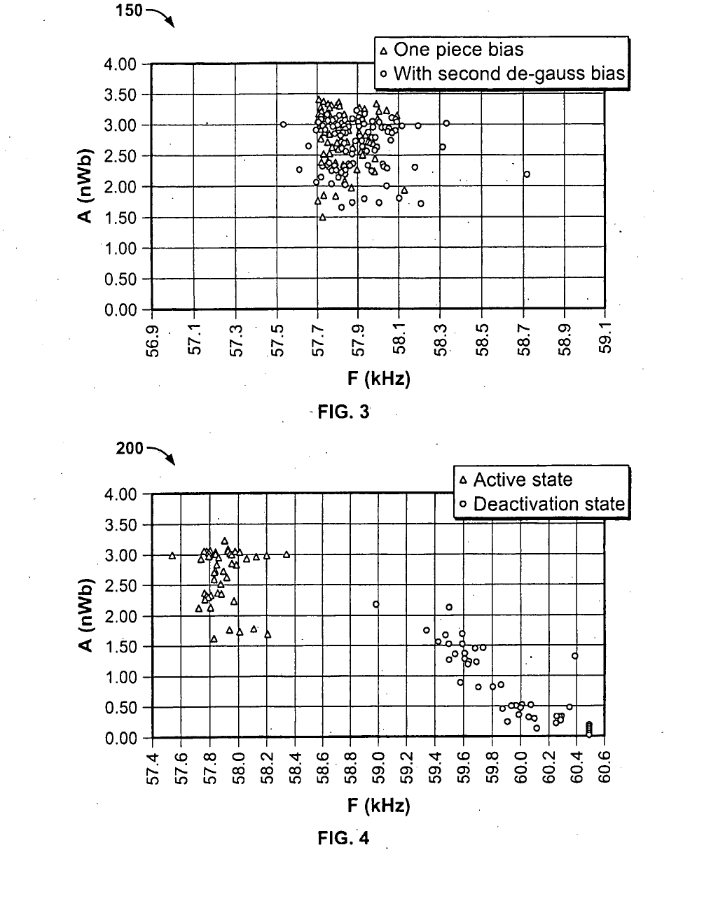

FIG. 3 is a chart 150 illustrating a distribution of multiple EAS labels 100 tested both before and after addition of the second biasing element 120. As illustrated, addition of the second biasing element 120 causes the average resonant frequency of EAS labels 100 to increase by about 80 Hz while an amplitude of the signal produced by EAS label 100 decreases by about five percent.

FIG. 4 is a chart 200 illustrating the results of deactivating EAS markers 100 by a deactivator located at about six inches above a surface of EAS markers 100. As illustrated, an average resonance frequency increased by about 2 kHz and amplitude decreased to seventy-two percent of active labels. Such a change in resonant properties after deactivation is similar to EAS labels that incorporate only a single biasing element.

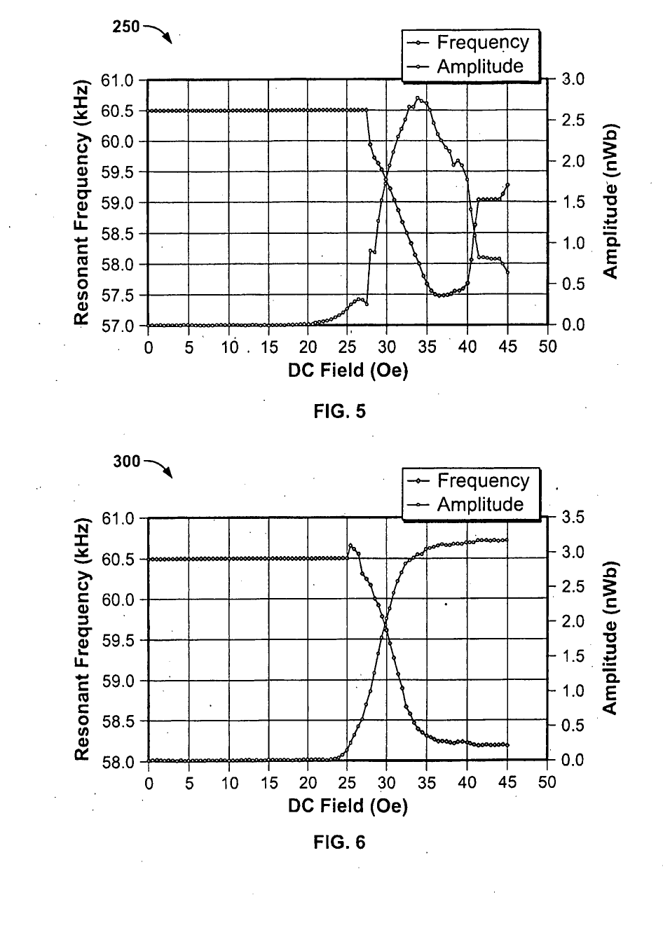

FIG. 5 is a chart 250 illustrating an effect of a DC magnetic field to a degaussed double-bias label (e.g., EAS marker 100). A DC magnetic field is applied along a longitudinal axis of the double bias label and then reduced to zero. A frequency and an amplitude from the EAS marker 100 are then measured. Initially, such field does not appear to change the biasing element's magnetic state until the magnetic field reaches a coercivity of twenty-five Oersteds. This is reflected by the stable resonator frequency and amplitude when the field strength is less than twenty-five Oersteds. When the DC field is larger than twenty-five Oersteds, however, the field starts to magnetize the biasing elements. Thus, a narrow window of DC field strength is present that partially magnetizes the biasing elements 114 and 120.

As a result, the double biasing elements provide adequate magnetic field for the resonator to function in the active state. In this example, the range for the DC field is between thirty-three and forty-three Oersteds. Beyond this upper limit, biasing elements 114 and 120 approach saturation where excessive field strength causes resonator frequency and amplitude outside the detection range. Once outside the detection range, EAS marker 100 is essentially deactivated again.

For comparison, FIG. 6 is a chart 300 illustrating the same DC field magnetizing effect on a known single-bias label. The field strength that brings the labels to an active state is about thirty-three Oersteds. However there is no upper limit in this case. A label with this configuration can be activated by any field greater than this strength.

The embodiments described above relate to an EAS marker which incorporates bias elements that are originally at differing levels of magnetization, but which can be deactivated and/or reactivated such that both bias elements are magnetized to the same level of magnetization. Additional embodiments of a double bias element EAS marker may include a permanently magnetized biasing element (e.g. a hard magnet having a high coercivity) and a biasing element with a low coercivity that can be magnetized and demagnetized as described above. As utilized herein, a high coercivity refers to a coercivity of about, or in excess of 100 Oersteds. Such a level of magnetization renders such devices difficult to demagnetize. In one embodiment of a permanently magnetized biasing element, the element is magnetized to a level of at least 1500 Oersteds.

In one embodiment of such an EAS marker, both elements are magnetized as the marker is prepared for use in a product. Having both biasing elements magnetized is sometimes referred to as being over biased. Deactivation of such an EAS marker includes demagnetization of the low coercivity element thereby changing an operating frequency of the EAS marker.

In another embodiment, the permanently magnetized biasing element is magnetized and the low coercivity biasing element is non-magnetized as the marker is prepared for use in a product. Deactivation of such a marker includes magnetization of the low coercivity product thereby changing an operating frequency of the EAS marker.

The various embodiments described herein provide a double-biasing element design (e.g., EAS marker 100) that limits the field level that can accidentally activate a degaussed label to a narrow range, which reduces the accidental or unintentional reactivation of EAS labels.

As used herein, the term “magnetostrictive element” refers to any active magnetic component that is capable, when properly activated, of producing a unique ring down signal in response to an interrogation signal. Also, the term “biasing element” as used herein refers to any control element including a magnetic material having a relatively high coercivity as compared to the coercivity of the magnetostrictive element, and which is capable of being magnetized or demagnetized (e.g., biased or unbiased) to control a mechanical resonant frequency of the magnetostrictive element.

The marker 100 described herein is applicable to a variety of EAS applications. For example, marker 100 is operable for so called “source tagging” where marker 100 is integrated into an item at manufacture.

While the invention has been described in terms of various specific embodiments, those skilled in the art will recognize that the invention can be practiced with modification within the spirit and scope of the claims.

What is claimed is:

1. A marker for use in a magnetomechanical electronic article surveillance (EAS) system, said marker comprising:
at least one resonator;
a housing configured to allow vibration therein of said at least one resonator;
at least one magnetized biasing element within said housing configured to provide a biasing magnetic field for said at least one resonator; and
at least one non-magnetized biasing element within said housing.

2. A marker according to claim 1 wherein said at least one resonator comprises an amorphous magnetostrictive element.

3. A marker according to claim 1 wherein said first biasing element and said second biasing element are configured having substantially the same dimensions and fabricated from the same material.

4. A marker according to claim 1 wherein said second biasing element is configured for magnetization in the presence of a magnetic field.

5. A marker according to claim 1 wherein said first and said second biasing elements are configured for magnetization when in the presence of a magnetic field, the magnetized first and second biasing elements together configured to yield a field strength that results in an operation of said at least one resonator outside of a frequency range of the EAS system.

6. A marker according to claim 1 comprising a plurality of adhesive layers, wherein said first and said second biasing elements are attached to said housing utilizing said adhesive layers.

7. A marker according to claim 1 wherein said first and said second biasing elements are configured for magnetization in the presence of a magnetic field, the magnetized first and second biasing elements together configured to change a resonant frequency of said at least one resonator.

8. A marker according to claim 1 wherein said at least one magnetized biasing element and said at least one non-magnetized biasing element are oriented in at least one of a stacked orientation and a side by side configuration.

9. A method of deactivating a marker within a magnetomechanical electronic article surveillance system, said method comprising:
providing the marker with a resonator;
configuring a first biasing element for use in the marker at a first magnetization level;
configuring a second biasing element for use in the marker at a second magnetization level; and
providing that the magnetization levels for the first and second biasing elements will be substantially equal upon a subsequent exposure to a magnetic field having a predetermined strength.

10. A method according to claim 9 further comprising exposing the first biasing element and the second biasing element to a magnetic field to change a resonant frequency of the resonator.

11. A method according to claim 9 further comprising fabricating the first biasing element and the second biasing element from the same material at substantially the same dimensions.

12. A method according to claim 9 wherein:
configuring a second biasing element comprises configuring the second biasing element with a magnetization level that is substantially zero; and
providing that the magnetization levels for the first and second biasing elements will be substantially equal comprises degaussing the first biasing element.

13. A method according to claim 9 further comprising attaching the first and second biasing elements within a housing utilizing adhesive layers.

14. An electronic article surveillance (EAS) system marker configured to resonate at a first frequency, and after deactivation thereof, said marker configured to resonate at a second frequency different than the first frequency upon a subsequent exposure to a magnetic field.

15. An EAS system marker according to claim 14 comprising:
at least one resonator;
a first biasing element magnetized to a magnetization level; and
a second non-magnetized biasing element.

16. An EAS system marker according to claim 15 wherein said first biasing element and said second biasing element are configured having substantially the same dimensions and fabricated from the same material.

17. An EAS system marker according to claim 15 wherein said second biasing element is configured to be magnetized in the presence of a magnetic field.

18. An EAS system marker according to claim 15 wherein, after deactivation of said first biasing element, said first and said second biasing elements are configured for magnetization when in the presence of a magnetic field.

19. An EAS system marker according to claim 15 wherein, after deactivation of said first biasing element, said first and said second biasing elements are configured for magnetization when in the presence of a magnetic field, the magnetized first and second biasing elements together configured to yield a field strength that results in said at least one resonator operating at a frequency different than a frequency of operation when only said first biasing element is magnetized.

20. An EAS system marker according to claim 15 comprising a housing and a plurality of adhesive layers, wherein said first and said second biasing elements are secured within said housing utilizing said adhesive layers.

21. An EAS system marker according to claim 15 wherein said at least one resonator comprises an amorphous magnetostrictive element.

22. A marker for use in a magnetomechanical electronic article surveillance (EAS) system, said marker comprising:
at least one resonator;
a housing configured to allow vibration therein of said at least one resonator;
at least one permanently magnetized biasing element within said housing configured to provide a biasing magnetic field for said at least one resonator; and
at least one biasing element within said housing having a coercivity that allows magnetization and demagnetization of said biasing element.

23. A marker according to claim 22 wherein said at least one low coercivity biasing element having a coercivity is magnetized in an activated state and demagnetized in a deactivated state.

24. A marker according to claim 22 wherein said at least one biasing element having a coercivity is unmagnetized in an activated state and magnetized in a deactivated state.

25. A marker according to claim 22 wherein said at least one biasing element having a coercivity is configured for magnetization in the presence of a magnetic field.

26. A marker according to claim 22 wherein said at least one biasing element having a coercivity is magnetized upon deactivation, the magnetized biasing elements together configured to yield a field strength that results in an operation of said at least one resonator outside of a frequency range of the EAS system.

27. A marker according to claim 22 wherein said at least one biasing element having a coercivity is demagnetized upon deactivation, said permanently magnetized biasing elements configured to yield a field strength that results in an operation of said at least one resonator outside of a frequency range of the EAS system.

28. A marker according to claim 22 wherein said at least one biasing element having a coercivity is configured for magnetization in the presence of a magnetic field, the magnetized said biasing elements having a coercivity and said permanently magnetized biasing elements together configured to change a resonant frequency of said at least one resonator.

29. A maker according to claim 22 wherein said permanently magnetized biasing elements have a coercivity of at least 100 Oersteds.
